(19) United States
(12) Patent Application Publication
(10) Pub. No.: US 2002/0146509 A1
(43) Pub. Date: Oct. 10, 2002

(54) Micronization process and polymer particles produced therefrom

(76) Inventors: George K. Kodokian, Kennett Square, PA (US); Keisha M. Wilson, Newark, DE (US); David L. Brinton, Wilmington, NC (US); Judith E. Hodgson, Wilmington, DE (US); James K. Odle, Newark, DE (US); Samuel D. Arthur, Wilmington, DE (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/023,616

(22) Filed: Dec. 18, 2001

Related U.S. Application Data
(60) Provisional application No. 60/266,810, filed on Feb. 6, 2001.

(51) Int. Cl. B05D 7/00

(52) U.S. Cl. 427/222

(57) ABSTRACT

The present invention relates to a process for producing substantially rounded thermosetting or thermoplastic polymer particles and also to a device used therefor. The process includes forming a mixture of polymer pellets with at least one surfactant in an aqueous medium, rapidly melting the polymer pellets under plug flow and plug free heating conditions, shearing the melted pellets into the polymer particles, and rapidly cooling the polymer particles under plug free cooling conditions. Thermosetting particles can include a blend of thermosetting polymers and crosslinking agents. The device provides for plug free conditions to ensure high production rates with substantially no clogging in the polymer conveying and polymer shearing means used in the device. The plug flow conditions ensure more uniform and predictable shearing conditions, since the polymer pellets under the plug flow condition results in substantially no pellet to pellet variation in the pellet temperature. As a result, the coatings resulting form the use of these polymer particles have predictable and uniform powder coating properties. The process produces aqueous polymer particle slurry, which if desired, may be converted into polymer powder by removing water. The polymer particles are particularly suited for powder coatings in automotive OEM and refinish applications, and industrial coatings.

### CROSS-REFERENCE TO RELATED APPLICATION

This application claims priority under 35 U.S.C. §119 from U.S. Provisional Application Ser. Nos. 60/266,810 (filed Feb. 06, 2001) which is incorporated by reference herein as if fully set forth.

### BACKGROUND OF THE INVENTION

1. Field of the Invention

This invention generally relates to a micronization process of producing polymer particles suitable for use in powder coating applications, and more particularly relates to producing an aqueous slurry or powder of substantially round polymer particles.

2. Description of Related Art

It is known to use powder coatings containing polymer particles for coating various substrates, such as metal, wood, cement, leather, ceramic and resinous substrates. Some of the typical methods utilize an electrostatic spray application or a fluidized bed of polymer particle powder in which the substrate to be coated is fully or partially sprayed or dipped to cover the substrate surface with polymer particles. The covered surface is generally then heated to melt the polymer particles to form a coating on the substrate surface. Powder particles from thermoplastic or thermosetting polymers are typically employed. The thermosetting polymer particles can be blended with a crosslinking agent during its preparation.

Another typically employed application method includes applying aqueous slurry of polymer particles over substrate surfaces by conventional application means, such as spraying, dip coating, brush coating or roller coating. Slurry coated surfaces are dried to remove moisture and then heated to melt the polymer particles to form a coating on the substrate surface.

Several methods are employed in producing polymer powders or powder slurries. One method involves mixing polymers with other additives, melt extruding the mixture and then cryogenically grinding the extrudate. Sometimes, the ground particles are reheated in water to blunt the sharp edges present on the cryogenically ground particles. FIG. 1 illustrates the polymer particles produced by such a method. One of the problems associated with cryogenically ground particles is they tend to have diverse particle size distribution.

Yet another method suited for producing polymer particles from a thermosetting polymer blended with a crosslinking agent is described by Kalck et al. in PCT/EP97/07109, published on Jun. 25, 1998. The Kalck method is directed to mixing a thermosetting polymer with a crosslinking agent and then melting the mixture into a viscous liquid melt, shearing the melt in a shearing device simultaneously supplied with water and emulsifier, and then rapidly cooling the sheared particles in less than 5 seconds, preferably in less than a second. Alternatively, the molten streams of thermosetting polymer and crosslinking agent are mixed in a molten state and then the mixed viscous melt is sheared in a multi-stage mixing/shearing device simultaneously supplied with water and emulsifier. One of the problems with such a device is the viscous melt in the conveying conduits, such as pipes, can clog up the shearing device and the conveying conduits. Moreover, the conveying conduits, which have to be kept heated to keep the ingredients in a molten state also tend to impart a varying process temperature history to the polymer particles, a problem further exacerbated by the presence of stagnant spots that are invariably present in any piping system. As a result, polymer particles containing a thermosetting polymer and crosslinking agent exposed to a varying process temperature history can result in particles having varying degrees of premature crosslinking. Thus, a coating resulting from the use of a powder coating composition or powder slurry containing such polymer particles would not have uniform coating properties, such as adhesion, gloss, flow-leveling and coating life. Therefore, a need exists for a process and a clog free device that produces substantially rounded polymer particles at high through put rates but does not impart varying process temperature history. The process and the device of the present invention fully address these needs.

### BRIEF SUMMARY OF THE INVENTION

The present invention is directed to a process for producing substantially round polymer particles comprising the steps of:

(i) forming a mixture comprising polymer pellets, an aqueous medium and at least one surfactant;

(ii) heating said mixture under plug flow and plug free heating conditions;

(iii) shearing heated mixture; and

(iv) cooling sheared mixture under plug free cooling conditions to produce said substantially round polymer particles.

The present invention is also directed to a device for producing substantially round polymer particles comprising:

(i) means for forming a mixture of polymer pellets, an aqueous medium and at least one surfactant;

(ii) means for heating said mixture under plug flow and plug free heating conditions;

(iii) means for shearing said heated mixture; and

(iv) means for cooling said sheared mixture under plug free cooling conditions.

One of the advantages of the process and device of the present invention is to produce thermosetting polymer particles that can comprise a thermosetting polymer, crosslinking agent, and surfactant and, if desired other suitable ingredients wherein the particles have substantially identical and uniform process temperature history. As a result, the degree of premature crosslinking does not substantially vary from one particle to another. Thus, coatings resulting from the use of such particles have predictable and uniform coating properties, such as adhesion, crack resistance, coating life, flow-leveling, etch and mar resistance. Plug flow conditions utilized in the present invention during heating and preferably during cooling of polymer ensures the aforedescribed advantage.

The plug flow conditions used during the heating of the polymer pellets also ensure uniform shearing of the heated polymer pellets, since the pellets are at uniform process temperature under the plug flow conditions. As a result, the shearing step becomes more predictable and uniform resulting in polymer particles having more rounded shapes as compared to conventional systems.

Another advantage of the process and device of the present invention is to produce polymer particles having desired particle size and particle size distribution in the form of either an aqueous particle slurry or a powder, either of which are especially suitable for use in the OEM automotive coatings and refinishes, and in industrial coatings.

Still another advantage of the process and device of the present invention over conventional systems is to produce thermosetting or thermoplastic polymer particles at high rates of productions with substantially no clogging either in polymer conveying systems or in shearing devices.

Yet another advantage of the process and device of the present invention over conventional systems is the ease in producing either thermoplastic or thermosetting polymer particles with substantially no downtime required in switching from one type of product to another. The process and device of the present invention also advantageously allows one to rapidly switch with substantially no downtime from one pigmented polymer particle to another color or to rapidly switch from one type of polymer to another.

### BRIEF DESCRIPTION OF THE DRAWINGS

FIG. 1 is a magnified view of the polymer particles produced by one of the conventional processes.

FIG. 1A is a schematic diagram of a device of the present invention used in the process of the present invention.

FIG. 2A is a plan view of a heating zone used in means for heating of the device.

FIG. 2B is a cross-sectional elevation view of the means for heating taken along the cross section 2B-2B in FIG. 2A.

FIG. 2C is a partial cross-sectional elevation view of the means for heating taken along the cross section 2C-2C in FIG. 2A.

FIG. 2D is a partial end view of a flange cover of a heating zone of the means for heating.

FIG. 2E is a partial three-dimensional view of the flange cover to illustrate the spatial positioning injection ports of the heating zone.

FIG. 3A is an alternate embodiment of the means for cooling used in the device of present invention.

FIG. 3B is a magnified end view of the means for cooling of FIG. 3A.

FIG. 3C is a partial cross-sectional elevation view of the means for cooling of FIG. 3B taken along the cross section 3C-3C in FIG. 3B.

FIG. 4 is a magnified view of the polymer particles of the present invention produced in Example A.

FIG. 5 is a magnified view of the polymer particles of the present invention produced in Example B.

FIG. 6 is a magnified view of the polymer particles of the present invention produced in Example C.

FIG. 7 is a magnified view of the polymer particles of the present invention produced in Example D.

FIG. 8A is a magnified view of the polymer pellets used for producing the polymer particles in Example E.

FIG. 8B is a magnified view of the polymer particles of the present invention produced in Example E.

FIG. 9A is a magnified view of the polymer pellets used for producing the polymer particles in Example F.

FIG. 9B is a magnified view of the polymer particles of the present invention produced in Example F.

FIG. 10A is a magnified view of the polymer pellets used for producing the polymer particles in Example G.

FIG. 10B is a magnified view of the polymer particles of the present invention produced in Example G.

### DETAILED DESCRIPTION OF THE INVENTION

As used herein:

“Plug free condition” means a flow condition through a pipe of polymer pellets in an aqueous medium wherein the pellets pass through a pipe having a substantially smooth bore and having substantially no obstructions or projections therein.

“Plug flow condition” means a flow condition through a pipe of polymer pellets in an aqueous medium wherein each polymer pellet passing through the pipe spends the same length of time in the pipe. As a result, the residence time history of the pellets during a heating step is substantially identical, thus substantially minimizing or eliminating variation in the degree of premature crosslinking of one thermosetting polymer pellet to the adjacent polymer pellet passing though the pipe. Similarly when a plug flow cooling condition is opted in cooling the aqueous medium containing polymer particles produced after shearing, the residence time history of the polymer particles during the cooling phase would be substantially identical. Thus, one can substantially minimize or eliminate variation in the degree of premature crosslinking of one thermosetting polymer particle to the adjacent polymer particle passing though the pipe during cooling.

One of the conditions for achieving a plug flow during the heating or cooling steps 5 is to ensure that the flow is turbulent and not laminar. Turbulence of a flow is ascertained by determining its Reynolds Number (See generally V. L. Streeter and E. B. Wylie, Fluid Mechanics, 7^{th} edition, McGraw-Hill Book Company, New York, 1979, pp. 195-198). The Reynolds Number of a fluid flowing through a pipe is calculated by using the following equation:

$$R = \frac{VD}{μ}$$

where R is the Reynolds Number, V is the transportation velocity, D is the inner diameter of the pipe and μ is the kinematic viscosity of the fluid passing through the pipe. A flow changes from laminar flow to a turbulent flow when Reynolds numbers range from 2000 to 4000. Reynolds numbers suitable for use in the present invention vary in the range of 2,000 to 500,000, preferably in the range of from 5,000 to 200,000.

Another critical requirement for the plug flow to occur is that a minimum transportation velocity must be achieved. This requirement is set by the Durand's minimum transportation velocity:

$${V}_{M} = {F [ 2 gD ( \frac{Δ ρ}{{ρ}_{medium}} ) ]}^{0.5}$$

where V_{M} is the minimum transportation velocity, F is an empirically derived constant that depends on the size of a polymer particle being conveyed, g is the acceleration due to gravity, D is the inner diameter of the pipe, Δρ is the absolute value of the difference between the densities of the polymer pellets and the aqueous medium and ρ_{medium} is the density of the aqueous medium. (See generally J. T. Davis, Calculation of Critical Velocities to Maintain Solids in Suspension in Horizontal Pipes, Chemical Engineering Science, v. 42, no. 7, 1987, 1667-1670). Typical values suitable for use in the present invention for F are in the range between 0.9 and 1.4, preferably in the range of 0.95 to 1.3; the coarser the particles the higher the F number and the higher will be the transportation velocity. Thus, by determining the Reynolds Number and Durand's minimum transportation velocity, an appropriate inner diameter of the pipe for a desired rate of production can be sized to produce plug flow.

“Amorphous polymers” are polymer molecules that are intertwined and arranged randomly. Most thermosetting polymers are amorphous.

“Crystalline polymers” are polymer molecules that are arranged closely and in a discernible order.

“Semi-crystalline polymers” are polymer molecules that include crystalline regions within an amorphous matrix. Most thermoplastic polymers are crystalline or semi-crystalline polymers.

Below a temperature known as the glass transition temperature (T_{g}), the molecules of a polymer material are frozen into a glassy state and above T_{g} the amorphous polymers enter a rubbery state in which the material becomes plastic or even liquid. In the case of crystalline polymers the liquid state is not reached until the melting temperature (Tₘ) is passed.

“Roundness” of a polymer particle is related to the overall shape of a polymer particle. Substantially round polymer particles produced by the process of the present invention have no sharp edges. As a result, substantially round polymer particles when charged electrostatically stick more evenly to a surface being electrostatically coated with polymer particles than the particles having sharp edges. Preferably, a substantially round particle has a substantially spherical shape.

“Particle size distribution” relates to the population density of a particle of a desired size in the population of polymer particles under study. Thus, a number close to 100 indicates that all of the particles would have the same size. Therefore, the higher the particle size distribution number, the more uniform will be the particle size. In the present invention, the particle size distribution varies from 1 to 100, preferably from 10 to 100 and more preferably from 20 to 100.

It should be noted that for the sake of clarity the same components are referred to by the same Arabic numerals throughout all the Figures referred to herein.

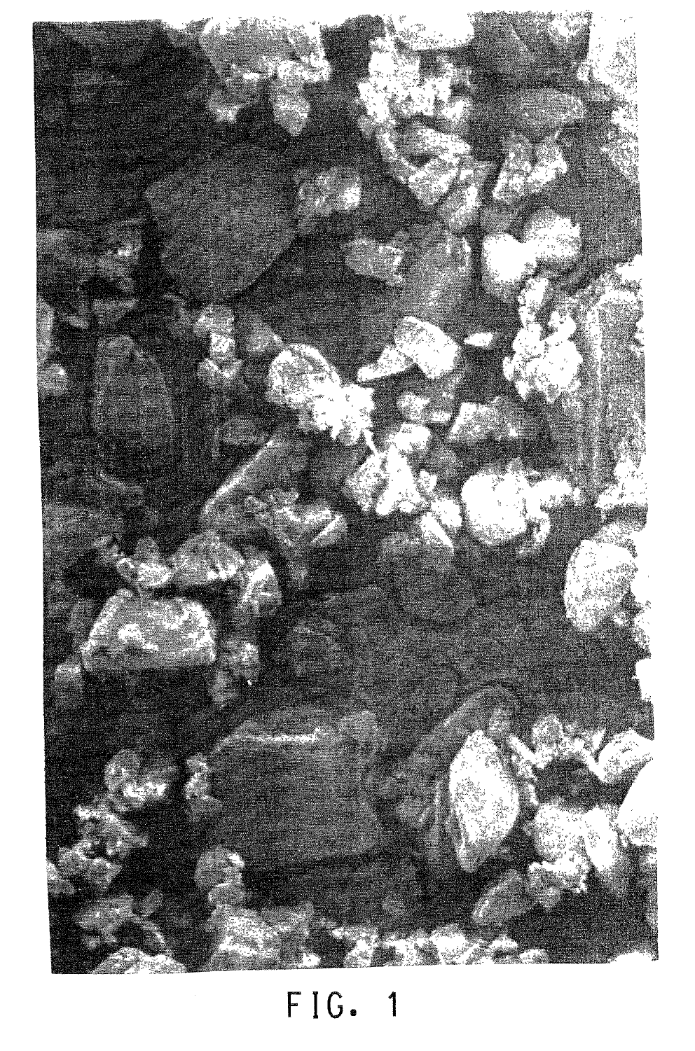

The schematic diagram in FIG. 1A illustrates the various components used in a device 1 in the present invention.

In its broadest aspects, device 1 for producing substantially round polymer particles includes:

(i) means 3 for forming a mixture of polymer pellets, an aqueous medium and at least one surfactant;

(ii) means 5 for heating the mixture under plug flow and plug free heating conditions;

(iii) means 7 for shearing the heated mixture; and

(iv) means 9 for cooling the sheared mixture under plug free cooling conditions.

Means 3 for forming include a slurry tank 10 into which polymer pellets, preferably stored in a hopper 12, are conveyed though a pellet intake 14. If desired, the delivery of the polymer pellets from hopper 12 can be automated and regulated by conveying the pellets via a conventional screw feeder (not shown) positioned between hopper 12 and pellet intake 14. Intakes 16 and 18 through which water, preferably deionized, and surfactant are respectively conveyed to slurry tank 10. If desired, tank 10 can be provided with additional intakes for conveying other suitable components, such as pigments, viscosity modifier, and water miscible co-solvents, to the aqueous medium in tank 10. Preferably, chemically inert materials, such as fiberglass or polyethylene, are used in the fabrication of tank 10. The contents in tank 10 are preferably agitated with a conventional stirrer 20, such as an air driven four-bladed impeller.

It should be understood that the order in which the mixture is formed in slurry tank 10 is not critical. For example, it is contemplated that the polymer pellets can include one or more surfactants blended therein, which are then conveyed to slurry tank 10. Alternatively, one can also add the same or yet another surfactant to slurry tank 10 along with the aforestated polymer pellets that include the surfactant blended therein.

A suction port of metering pump means 22 is connected to tank 10 to convey the mixture, under pressure, from tank 10 to heating means 5 via delivery port 24. Preferably, metering pump means 22 include a positive displacement pump having a rotor in a screw design configuration, all covered with nitrile rubber. One suitable pump available from Philip H. Kline & Co., Inc.; Pottstown, Pa. is Moyno® pump Model 6M2 with # 3 drive end. If desired, metering pumping means 22 may include more than one pump connected in series to increase the pumping pressure in stages. Means to measure the flow rate and the pressure (not shown) of the mixture supplied by metering pump means 22 is monitored to attain the plug flow condition.

Means 5 for heating include a plurality of heating sections 26 interposed with a plurality of heating zones 28. Preferably, for the sake of uniformity and flexibility, substantially identical plurality of heating sections 26 and heating zone 28 are utilized. However, if desired heating sections 26 and heating zones 28 of unequal length or sizes can be utilized. Heating section 26 has a substantially elongated shape, preferably tubular, to permit the aqueous medium to flow therethrough without substantially any obstruction, i.e., under a plug free condition. Pipes having substantially no obstruction and smooth bore are preferred. As a result, polymer pellets in the mixture can be heated at substantially high throughput rates. Heating section 26 is preferably a transparent tube that permits the user to make a visual inspection of the mixture passing therethrough. By way of example, heating sections 26 made from a 17.8 mm (0.7 inch) inner diameter transparent tempered glass tubes having a length of 152.4 mm (6 inches) supplied by QVF Process Systems, Inc., Horseheads, N.Y. are well suited for use in the present invention. If no visual inspection is needed, then heating section 26 may be made of chemically inert material, such as steel, and stainless steel.

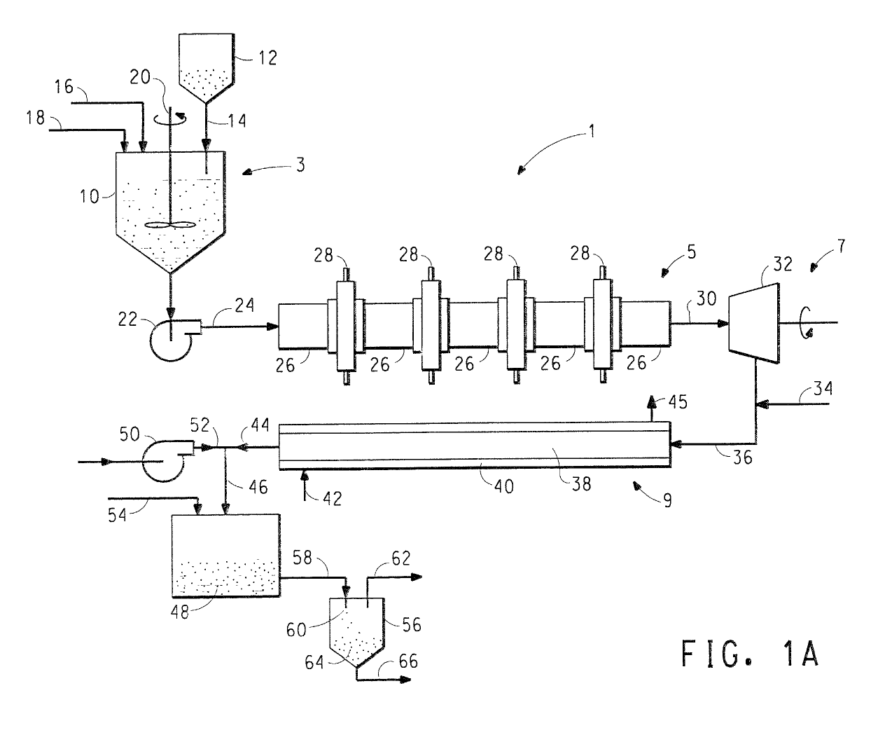

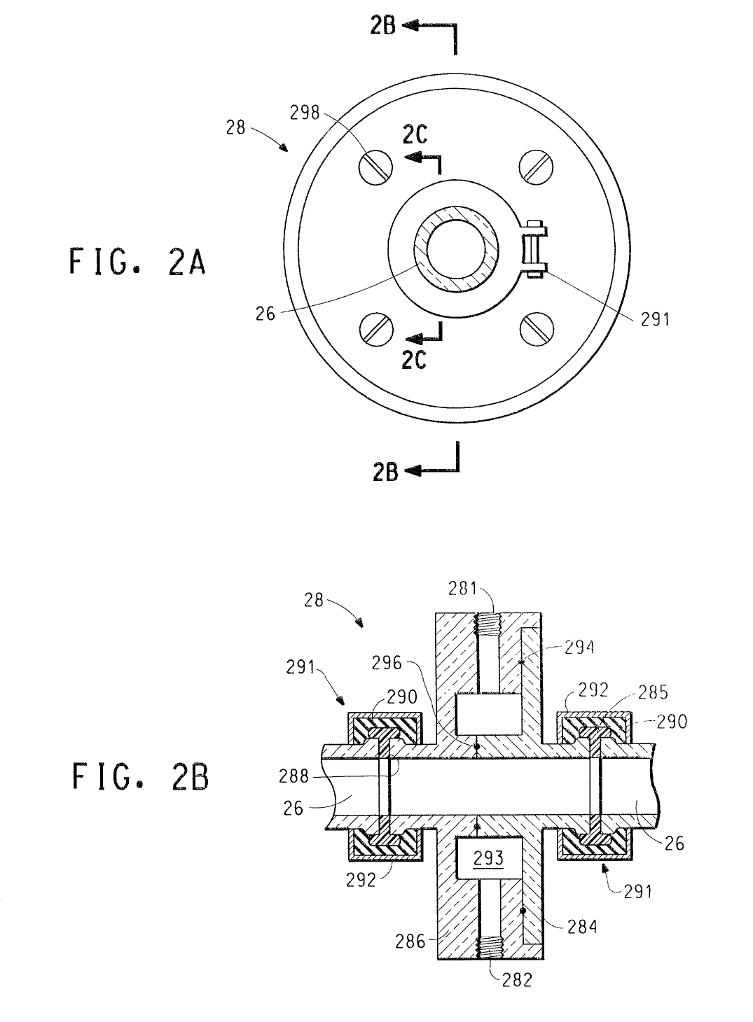

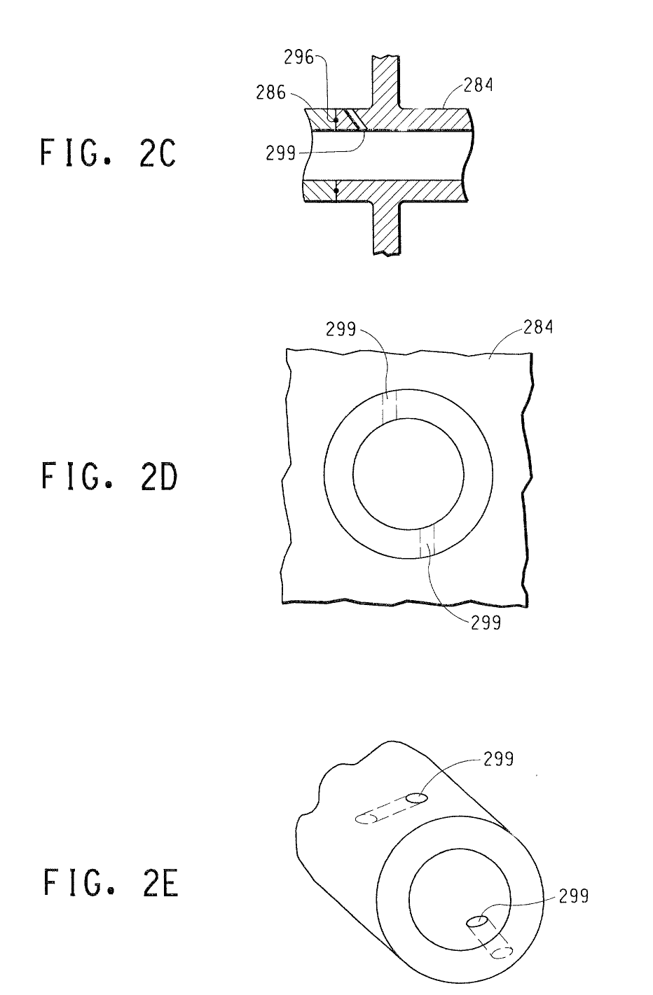

Details of heating zone 28 can be seen FIGS. 2A, 2B and 2C. Heating zone 28 includes a flange 286 provided with a heat transfer fluid intake 281 and drain 282. A typical heat transfer fluid used is steam. However, other heating fluids, included heated gas are also contemplated for use in the present invention. A steam pocket 293 within flange 286 is sealed by conventional sealing means, such as flange ‘O’ ring 294, contacted against a flange cover 284 to prevent leakage of the heat transfer fluid, which is typically supplied at high temperature and pressure. When steam is used as the fluid, steam is supplied at a temperature and pressure, respectively in the range from 20 KPa at 60° C. to 22 MPa at 374° C., preferably from 101 KPa at 100° C. to 4 MPa at 250° C.

Typically securing means, such as screws 298, shown in FIG. 2A are used to secure flange cover 284 against flange 286. Heating sections 26 are sealably anchored to flange 286 and flange cover 284 by clamp assembly 291. Clamp assembly 291 includes a gasket insert 288, a sealing gasket 290 and a wrap around metal clamp 292. Gasket insert 288 typically made from a heat insulating material, such as Teflon® tetrafluroethylene, supplied DuPont Company, Wilmington, Del. is interposed between centrally disposed openings on flange 286 and flange cover 284 to prevent transfer of heat from heating zone 28 to heating sections 26. Sealing gasket 290 made from a flexible material, such as silicon rubber is mounted over gasket insert 288 and substantially identical lips provided on heating sections 26 and the openings on flange 286 and flange cover 284. Clamp 292 is mounted over sealing gasket 290 to sealably secure heating sections 26 to heating zone 28.

Centrally disposed tubular projection on flange cover 284 abutting against a mating tubular projection on flange 286 is sealed with an ‘O’ ring seal 296 to allow a plug free passage of the mixture through means 5 for heating. As shown in FIGS. 2C, 2D and 2E, two or more injection ports 299 are preferably provided on the centrally disposed tubular projection on flange cover 284 to permit injection of heat transfer fluid supplied to heating zone 28. The orifice of injection port 299 is kept small enough to prevent cavitation (formation of vapor bubbles) in heating zones 28. As shown in FIGS. 2D and 2E, injection ports 299 are preferably positioned opposite to one another on the centrally disposed tubular projection on flange cover 284, such that the injected fluid from one port 299 impinges against the injected fluid from the opposite port 299. Ports 299 are offset to produce a swirl pattern within the mixture to improve the heat transfer from the heat transfer fluid to the polymer pellets. Alternatively, ports 299 can be positioned diametrically opposite to one another such that the injected fluid from one port 299 directly impinges against the injected fluid from the opposite port 299. It is well within the scope of this invention to provide a single port 299 or a plurality of ports 299, such as, for example, 3 or 4 ports positioned at 180 degrees from each other, or at 90 degrees from each other, respectively.

To further improve the heat transfer from the heat transfer fluid to the polymer pellets, the swirl pattern created in adjacent heating zones 28 may be reversed at some places or alternated thorough out means 5 for heating to further improve the heart transfer. Thus, if a clockwise swirl pattern is created in one heating zone 28, ports 299 on adjacent flange covers 284 in adjacent heating zone 28 could be repositioned by up to 180° to produce a counter-clockwise swirl pattern.

Means 5 for heating may be positioned vertically (as a column) or horizontally. A horizontal configuration is preferred, since the plug flow condition can be achieved at lower transportation velocity of the mixture passing through the heating means than that obtained in a column configuration. Preferably, heating means 5 is inclined to accumulate a pocket of air in the mixture passing through heating means 5 from pump means 22 towards shearing means 7 described below, which can then be vented out during start up. The end of means for heating 5 proximate to metering pump means 22 is positioned 1 to 10 degrees higher than the end of means 5 for heating proximate to means 7 for shearing.

The length of heating means 5 resulting from linearly securing a plurality of heating sections 26 and heating zones 28 is adjusted to heat the core of the pellets to a desired temperature above the melting temperature or glass transition temperature. Generally, the polymer pellets are heated above the melting temperature of the polymer. The time required to heat the core of the pellet can be calculated by using the following equation:

$$\frac{{T}_{1} - T}{{T}_{1} - {T}_{0}} = 2 {\sum }_{n = 0}^{∞} \frac{{( - 1 )}^{n}}{( n + 1 / 2 ) π} {ⅇ}^{- {( n + \frac{1}{2} )}^{2} {π}^{2} α \frac{t}{{r}^{2}}} cos ( n + \frac{1}{2} ) \frac{π r}{R}$$

where r is the radius of the core of the pellet, R is the radius of the pellet, T is the temperature at radius r, T₀ is the temperature of the medium, T₁ is the initial temperature of the pellet, and α is the thermal diffusivity of the polymer.

Based on the requirement necessary to satisfy the minimum transportation velocity, a residence time vs. length was estimated. The residence time was then checked against the results from the equation above. Based on these calculations the largest pellet size that can be used for heating sections 26 sizes described below is equal or less than 3 mm (⅛ inch). Therefore, a good balance can be achieved with a plurality of glass heating sections 26 each having an inner diameter of 17.8 mm at an over all length of 3.05 meter (10 feet) and metering pump means 22 supplying the mixture passing through heating means 5 at a flow rate in the range of 2.84 to 7.6 liters per minute (0.75 to 2 gallons per minute) to heat the core of a 3 mm (⅛ inch) pellets to within 95% of the temperature of the mixture.

The temperature of the mixture, heat transfer fluid supplied to the mixture and the heating medium are monitored by means of conventional thermocouples (not shown) to control the temperature of the mixture. The pressure and the flow rate of heat transfer fluid supplied to heating zones 28 is also monitored and controlled by conventional means. If desired, the entire means 5 for heating can be enclosed in an enclosure, preferably a transparent enclosure, for safety.

An output port 30 exiting from heating means 5 enters shearing means 7, which include one or more conventional shear devices 32. One suitable shearing device supplied by E.T. Oakes Corporation, Hauppauge, N.Y., Model No. 4MB1A is particularly preferred. However, applicants contemplate using a variety of other suitable shear devices to shear the heated polymer pellets supplied from heating means 5 into polymer particles of desired size, sphericity and particle size distribution.

If desired, one or more additional components, such as a catalyst, surfactant or any other additives, can be introduced at a desired rate via input port 34 positioned on an output passage 36 exiting from shearing device 32 or at output port 30 exiting from heating means 5. As a result, catalyst can thus come in contact with sheared polymer particles before they are cooled, preferably to room temperature by utilizing cooling means 9. However, applicants contemplate suitably positioning one or more ports anywhere in device 1 to introduce one or more additional components.

Cooling means 9 include an elongated cooling passage 38, preferably a metallic tube, connected to output passage 36 and free from any substantial obstruction to permit passage of the mixture therethrough under the plug free conditions. A cooling jacket 40 surrounds cooling passage 38 supplied with a conventional coolant, such as water, a blend of water and ethylene glycol, entering from a port 42 and exiting from a port 45 thereby providing a cross-convectional heat transfer for improved heat transfer efficiency. The temperature and the rate at which the coolant is supplied are monitored and controlled by conventional means (not shown) to attain desired cooling rates. Means 9 for cooling may be optionally provided with an axially disposed agitator to prevent the polymer particles from settling down during the passage though cooling means 9.

Means 9 for cooling may be positioned vertically (as a column) or horizontally. Horizontal configuration is preferred, since the plug flow condition can be achieved at lower transportation velocity of the mixture passing through heating means 5 than that obtained in a column configuration. Preferably, means 9 for cooling are inclined to accumulate air in the mixture passing through means 9 for cooling from shearing means 7 towards passage 44, which then can be vented out during the start up. The end of means 9 for cooling proximate to shearing means 7 is positioned 1 to 10 degrees lower than the end of means 9 for cooling proximate to passage 44.

In order to prevent cavitation either in heating means 5 or in cooling means 9, it is desirable that the operating pressure of the process is maintained at a pressure that prevents boiling of the individual components in the mixture or the mixture itself. The mixture containing the polymer particles can be removed from device 1 in various ways while still maintaining the operating pressure that prevents cavitation. One of the ways of reducing the operating pressure exiting from means 9 for cooling to atmospheric pressure is shown in FIG. 1A. A delivery port 52 of pressure let-down pump means 50 is connected to an exit passage 44 to provide a back pressure against the operating pressure exiting from exit passage 44. Thus, by monitoring the exit pressure from exit passage 44, the back pressure provided by pressure let-down pump means 50 can be constantly adjusted to maintain the pressure in a process output passage 46 at atmospheric pressure. The mixture containing the polymer particles can then be stored in a storage tank 48. If desired, additional water may be added via port 54 to storage tank 48. The mixture containing the polymer particles, also known as aqueous slurry can be applied conventionally, by such means, spraying, dipping and roller coating, over a wide variety of substrate surfaces.

In addition to the detailed description of the preferred embodiment provided herein, it should be understood that the present invention may be embodied in other various forms.

If desired, device 1 of the present invention can include means for producing a powder of polymer particles obtained by evaporating the aqueous medium from the aqueous slurry. As shown in FIG. 1A, the aqueous slurry is conveyed through an exit passage 58 to an evaporation chamber 56. The aqueous slurry is flashed though a flash nozzle 60 within chamber 56 for removing the volatiles via an exhaust port 62. Evaporation chamber 56 is preferably maintained under vacuum for removing the volatiles from the aqueous slurry. Evaporation chamber 56 is provided with a conventional exit port 66 to remove polymer particles 64 produced in a powder form from evaporation chamber 56.

Applicants contemplate a variety of alternate embodiments to the aforedescribed embodiment. For example, a capillary tube may be substituted for pressure let-down pump means 50 to bring the operating pressure down to atmospheric pressure.

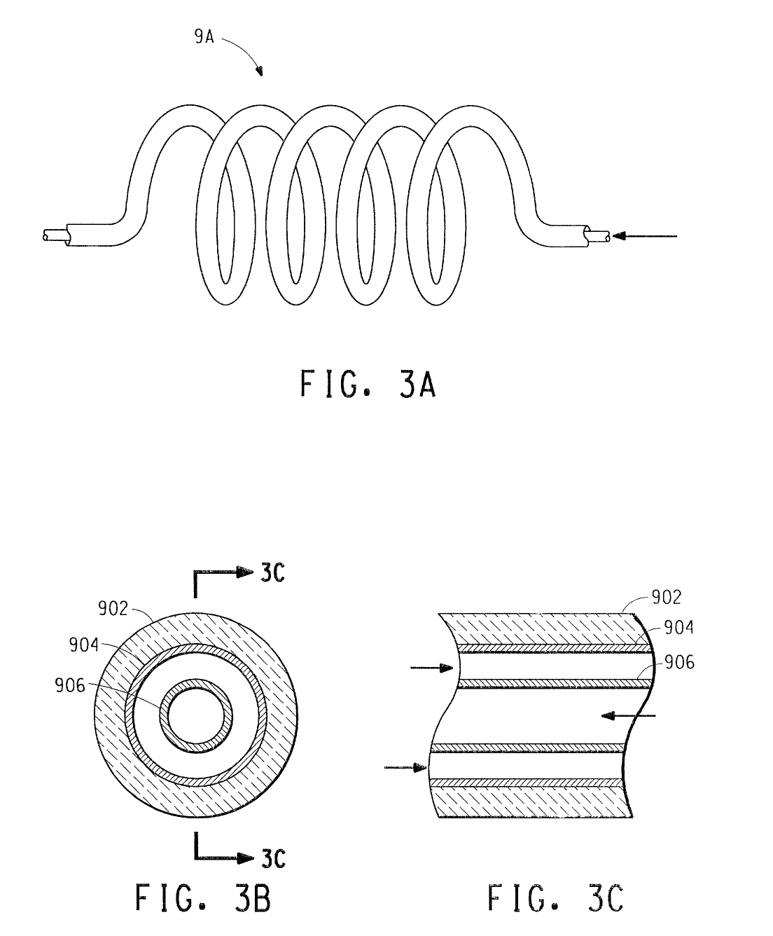

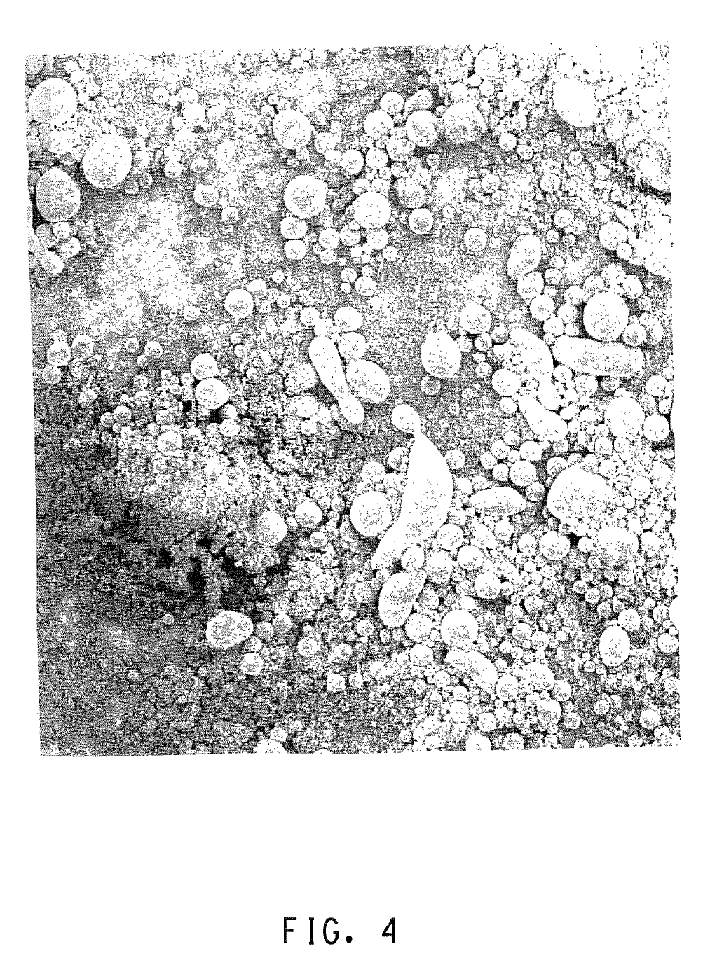

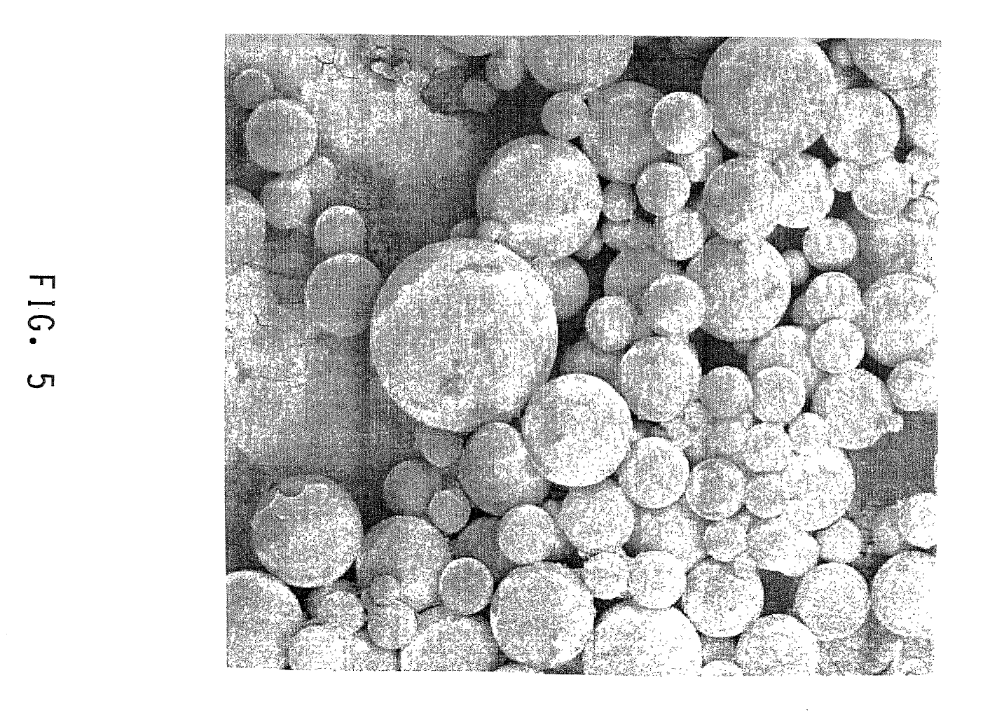

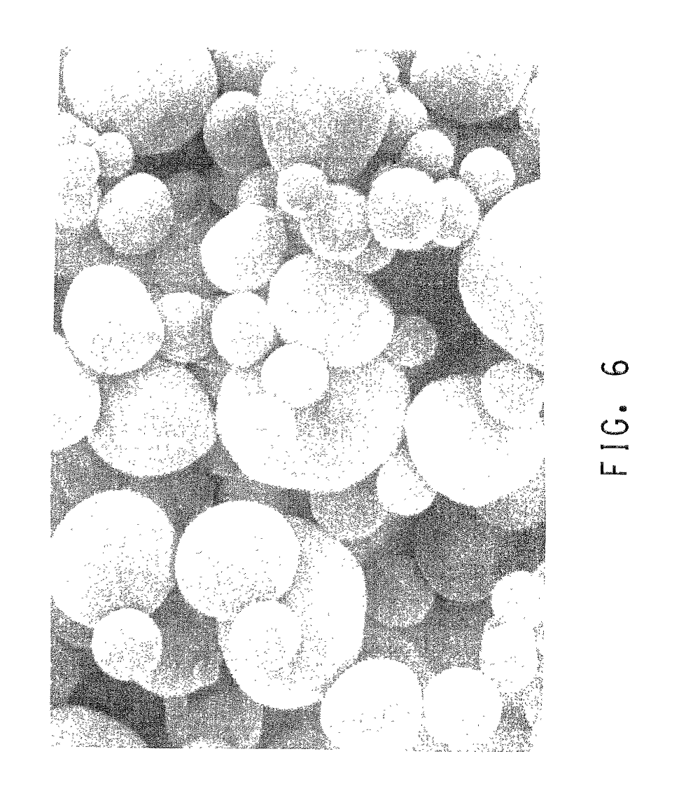

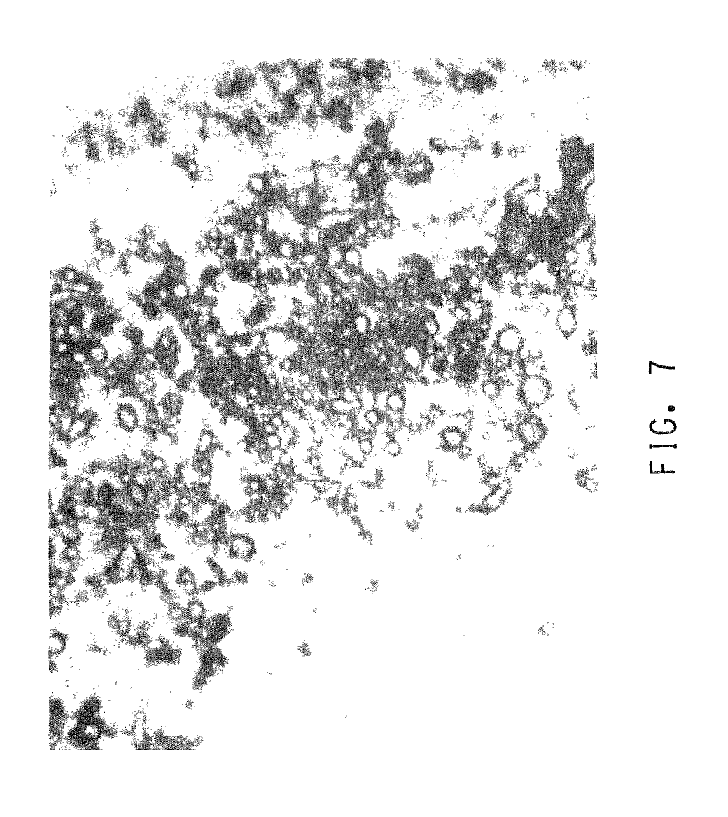

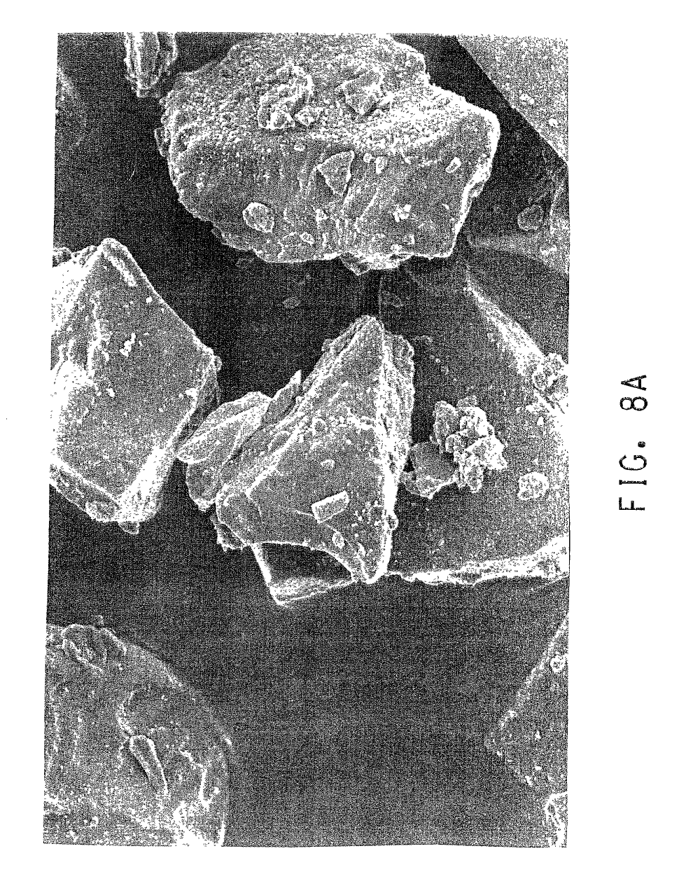

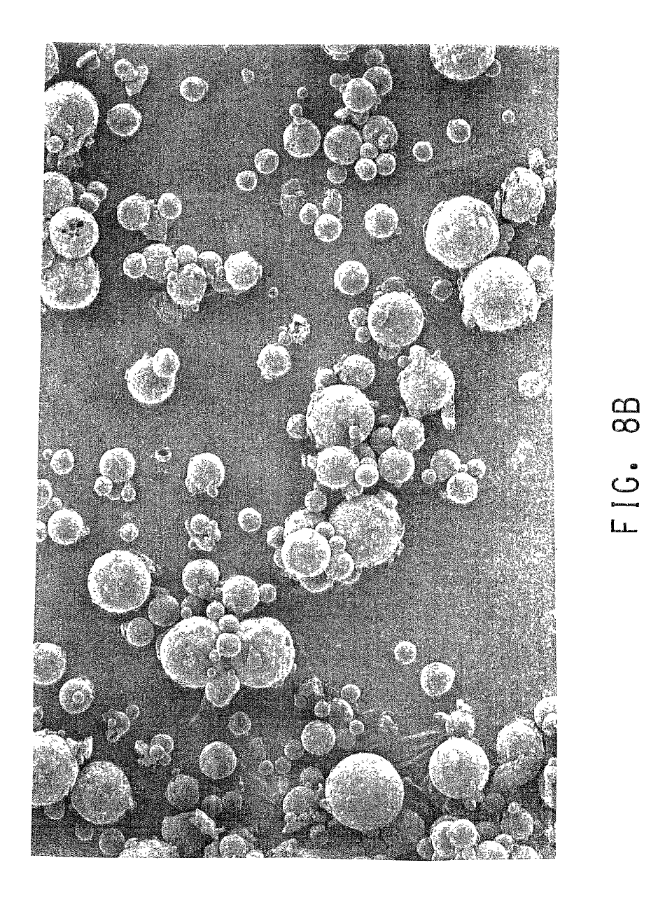

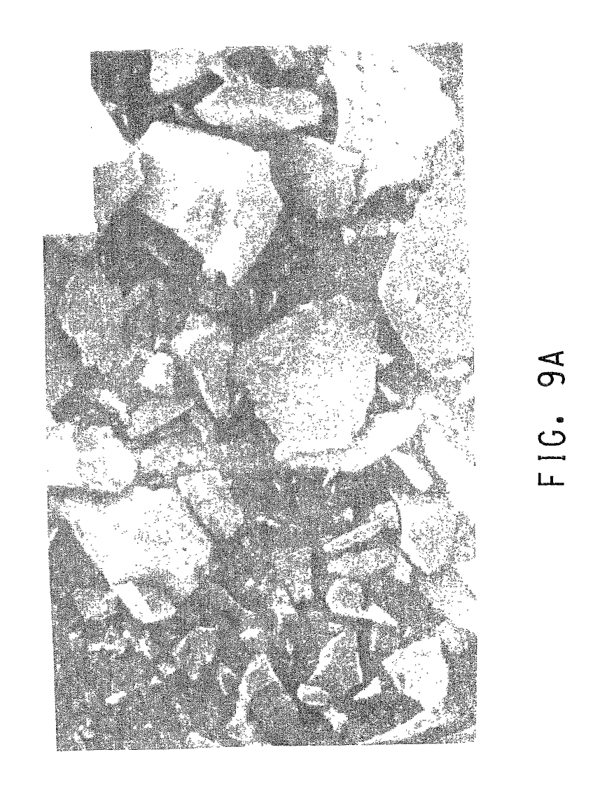

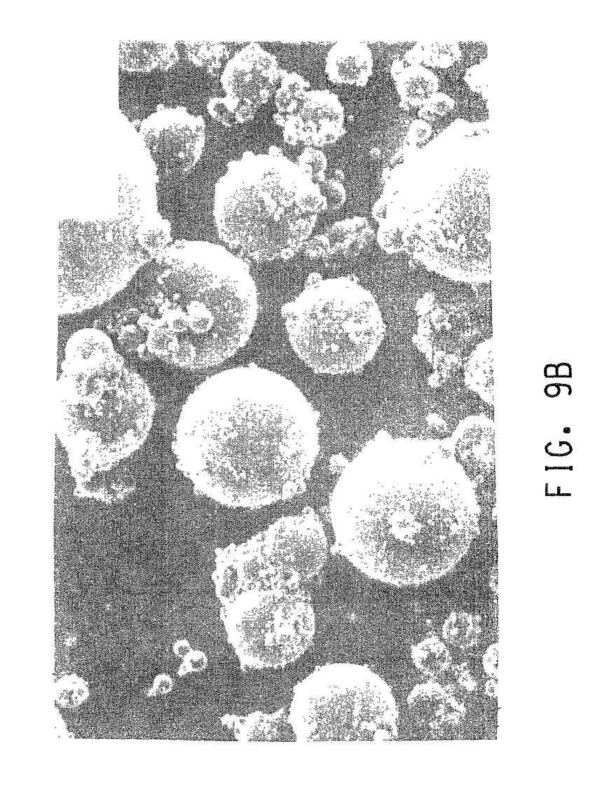

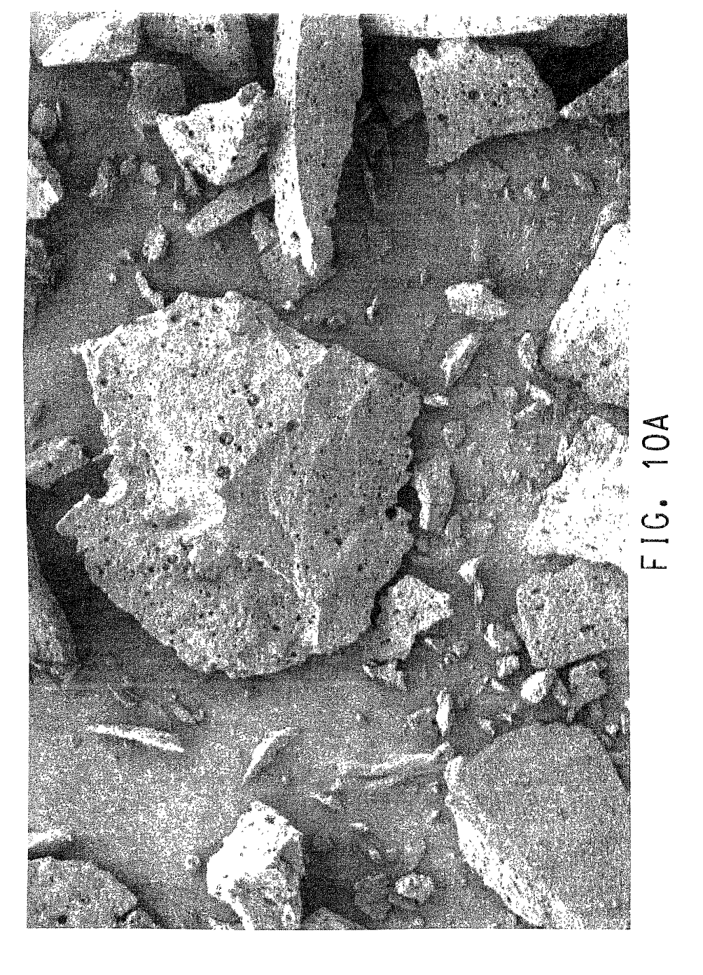

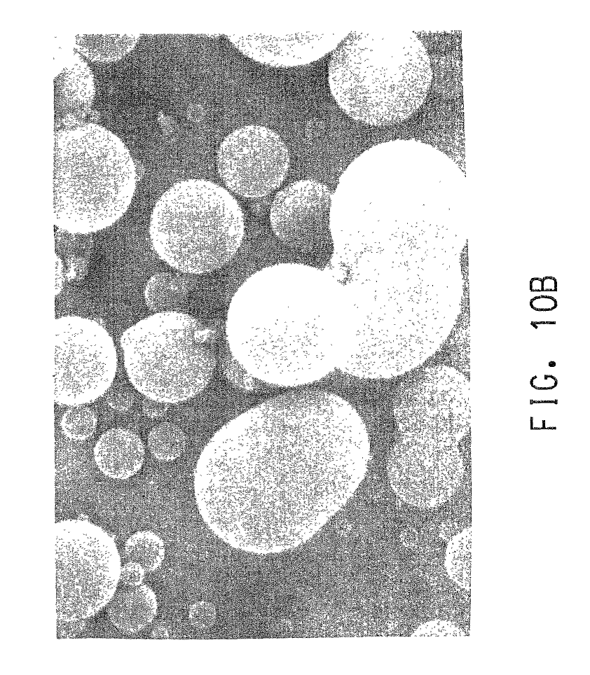

An alternative embodiment 9A to cooling means 9 is shown in FIGS. 3A, 3B and 3C. Means 9A include co-axially coiled outer and inner tubes 904 and 906, respectively coiled to increase the cooling surface without increasing the space required for cooling means 9A. An insulator 902 covers the outer surface of tube 904 to substantially insulate cooling medium passing between outer tube 904 and inner tube 906. For improved cooling efficiency coolant flows in opposite direction to the flow of the mixture passing through inner tube 906.

If desired and depending upon the chemical make-up and size of the polymer pellets, and the viscosity of pellets being sheared under molten conditions, additional shear devices may be used instead of a single shear device 32. It is further contemplated that the sheared particles existing from the first shear device may be reheated again through another set of heating means, similar to heating means 5, before re-shearing the polymer particles through a second set of a shear device.

Even though steam as a heating fluid is preferred, it is within the purview of this invention to contemplate other water soluble heat transfer fluids, such as methyl ethyl ketone, methyl amyl ketone, acetone, ethylene glycol or blends thereof. However, it is essential that such fluids do not affect the plug flow of the mixture. It is also contemplated that the mixture may contain miscible solvents or that the aqueous medium may be substituted with a non-aqueous liquid medium having boiling point higher than the melting point of the polymer pellets.

In operation, the process of the present invention, step (i) for producing substantially round polymer particles includes forming a mixture of the polymer pellets, at least one surfactant and an aqueous medium in slurry tank 3. Preferably, the pellets are supplied from pellet hopper 12. The aqueous medium includes water, preferably deionized water. If desired and depending on the chemical make-up of polymer pellets being sheared, one or more miscible co-solvents, such as primary, secondary and tertiary alcohols, methyl ethyl ketone, and methyl amyl ketone may also be included in aqueous medium. The selection of the surfactant used typically depends upon the chemical make-up of the polymer pellets being sheared. As stated earlier, the surfactants can be blended in with the polymer to form the polymer pellets before the pellets are conveyed to slurry tank 10. Generally, the surfactant is selected from at least one member of the group consisting of ionic, nonionic surfactants and a combination thereof. Preferred ionic surfactants are those formed in situ by the reaction of one or more of ammonium hydroxide, triethanolamine, morpholine and dimethyl ethanolamine with the carboxyl functionality integral to the copolymer. Other suitable ionic surfactants include ammonium lauryl sulfate, sodium lauryl sulfate and sodium dodecyl benzene sulfonate. Sodium lauryl sulfate and sodium dodecyl benzene sulfonate are particularly preferred with thermosetting polymers, such as, for example, polyester-epoxy hybrids and glycidyl methacrylates with 1,1 2-dodecanediacid. Preferred nonionic surfactants are polyoxypropylene-polyoxyethylene block copolymer (Pluronic® F-98 supplied by BASF Performance Chemicals in Mount Olive, N.J.), alkylphenol thioxylates, and ethyleneoxide-propylene glycol polymers. Nonionic surfactants having a cloud point in the range of 100° C. to 150° C. are particularly preferred. The cloud point is defined as the temperature at which a surfactant begins to dehydrate and self-associate rather than remain soluble in water. The surfactant concentration should be sufficient to prevent coalescence of polymer particles formed in means 7 for shearing, described below. Generally, the surfactant concentration in the range of about 0.001% to 25% by weight of the polymer pellets, preferably in the range of about 0.01% to 5% of the ionic surfactant is added to the mixture. In addition, in the range of about 0.001% to 25% by weight of the polymer pellets, preferably in the range of about 0.1% to 10% of the nonionic surfactant can be added to the mixture.

Typically, one or more other conventional components, such as, for example, a pigment (metallic and non-metallic pigments), dye, anticorrosion agent, anti-foaming agent, catalyst, ultraviolet light (UV) stabilizer, UV absorber, antioxidant, flow modifier, degassing aid, filler, extender, gloss-reducing additive, texturizing aid, abrasion resisting additive, anti-microbial agent, biocide, fungicide, photo-initiator, pH modifier, thorough-cure modifier, color stabilizer or a leveling agent can be also included in the mixture during the step (i). Alternatively, the aforedescribed components can be blended in the polymer pellets themselves or can be conveniently introduced at any point in device 1.

The polymer pellets suitable for use in the present invention include one or more conventional thermoplastic or thermosetting polymers that may be crystalline, semi-crystalline or amorphous. If desired a blend of one or more thermoplastic and/or one or more thermosetting polymers can be also used.

The polymer pellets may be in any form including but not limited to powder, flake or chopped extrudate. Since the pellets are heated in the heating step described below, applicants have found that when heating means 5 having the dimensions described herein are used, the core of polymer pellets having less than 3 mm in size can be heated more readily during the heating step than the core of pellets of a larger size. However, as described earlier, the upper limit of the polymer pellet size depends upon the inner diameter of heating sections 26. Thus, the larger the inner diameter of heating section 26, the higher can be the upper limit of the polymer pellet size. Generally, the inner diameter of heating sections 26 is about 8 to 10 times the size of the polymer pellet being heated. The polymer pellet concentration can range from about 0.5 to 50% by volume, based on the volume of the mixture. A polymer concentration below 40%, more preferably 10% to 35%, is preferred since the viscosity of the aqueous slurry increases rapidly as the concentration of polymer pellet approaches that at which the mixture would behave as a wet cake rather than a liquid.

Some of the suitable thermoplastic polymer and copolymer that can be used in this invention are disclosed in U.S. Pat. Nos. 3,933,954, 3,264,272 and Canadian Pat. No. 655,298, all of which are hereby incorporated by reference. The suitable polymers are copolymers of α-olefins of the formula R——CH═CH₂, where R is hydrogen or an alkyl radical of 1 to 8 carbon atoms; and α,β-ethylenically unsaturated carboxylic acids having from 3 to 8 carbon atoms; and, optionally, a monoethylenically unsaturated monomer. Suitable olefins include ethylene, propylene, butene-1, pentene-1, hexene-1, heptene-1, 3-methylbutene-1, and 4-methylpentene-1. Examples of α, β-ethylenically unsaturated carboxylic acids are acrylic acid, methacrylic acid, ethacrylic acid, itaconic acid, maleic acid, fumaric acid, monoesters of the dicarboxylic acids, such as methyl hydrogen maleate, methyl hydrogen fumarate, ethyl hydrogen fumarate and maleic anhydride. Although maleic anhydride is not a carboxylic acid in that it has no hydrogen attached to the carboxyl groups, it can be considered an acid for the purposes of the present invention because of its chemical reactivity being that of an acid. Similarly, other a, α,β-monoethylenically unsaturated anhydrides of carboxylic acids can be employed. The preferred unsaturated carboxylic acids are methacrylic and acrylic acids. As indicated, the concentration of acidic monomer in the copolymer is from 0.2 mol percent to 25 mol percent, and, preferably, from 1 to 10 mol percent.

The copolymer base need not necessarily comprise a two-component polymer. Thus, although the olefin content of the copolymer should be at least 50 mol percent, more than one olefin can be employed to provide the hydrocarbon nature of the copolymer base. Additionally, other copolymerizable monoethylenically unsaturated monomers, mentioned in the following paragraph, can be employed in combination with the olefin and the carboxylic acid comonomer. The scope of base copolymers suitable for use in the present invention is illustrated by the following two component examples:

Ethylene/acrylic acid copolymers, ethylene/methacrylic acid copolymers, ethylene/itaconic acid copolymers, ethylene/methyl hydrogen maleate copolymers, and ethylene/maleic acid copolymers. Examples of tricomponent copolymers include: ethylene/acrylic acid/methyl methacrylate copolymers, ethylene/methacrylic acid/ethyl acrylate copolymers, ethylene/itaconic acid/methyl methacrylate copolymers, ethylene/methyl hydrogen maleate/ethyl acrylate copolymers, ethylene/methacrylic acid/vinyl acetate copolymers, ethylene/acrylic acid/vinyl alcohol copolymers, ethylene/propylene/acrylic acid copolymers, ethylene/styrene/acrylic acid copolymers, ethylene/methacrylic acid/acrylonitrile copolymers, ethylene/fumaric acid/vinyl methyl ether copolymers, ethylene/vinyl chloride/acrylic acid copolymers, ethylene/vinylidene chloride/acrylic acid copolymers, ethylene/vinyl fluoride/methacrylic acid copolymers, and ethylene/chlorotrifluoroethylene/methacrylic acid copolymers.

In addition to the third monomer component of the ionic copolymer stated above, additional third monomeric components can be an alkyl ester of an α,β-ethylenically unsaturated carboxylic acid of 3 to 8 carbon atoms where the alkyl radical has 4 to 18 carbon atoms. Particularly preferred are the terpolymers obtained from the copolymerization of ethylene, methacrylic acid, and alkyl esters of methacrylic acid or acrylic acid with butanol. The concentration of this optional component is 0.2 mol to 25 mol percent, based on the weight of copolymer, preferably from 1 mol to 10 mol percent. Representative examples of the third component include n-butyl acrylate, isobutyl acrylate, secondary butyl acrylate, tertiary butyl acrylate, n-butyl methacrylate, isobutyl methacrylate, sec-butyl methacrylate, t-butyl methacrylate, n-pentyl acrylate, n-pentyl methacrylate, isopentyl acrylate, isopentyl methacrylate, n-hexyl acrylate, n-hexyl methacrylate, 2-ethyl-hexyl acrylate, 2-ethyl-hexyl methacrylate, stearyl acrylate, stearyl methacrylate, n-butyl ethacrylate, 2-ethyl hexyl ethacrylate. Also, the third component includes mono- and di-esters of 4 to 8 carbon atom dicarboxylic acids such as n-butyl hydrogen maleate, sec-butyl hydrogen maleate, isobutyl hydrogen maleate, t-butyl hydrogen maleate, 2-ethyl hexyl hydrogen maleate, stearyl hydrogen maleate, n-butyl hydrogen fumarate, sec-butyl hydrogen fumarate, isobutyl hydrogen fumarate, t-butyl hydrogen fumarate, 2-ethyl hexyl hydrogen fumarate, stearyl hydrogen fumarate, n-butyl fumarate, sec-butyl fumarate, isobutyl fumarate, t-butyl fumarate, 2-ethyl hexyl fumarate, stearyl fumarate, n-butyl maleate, sec-butyl maleate, isobutyl maleate, t-butyl maleate, 2-ethyl hexyl maleate, stearyl maleate. The preferred alkyl esters contain alkyl groups of 4 to 8 carbon atoms. The most preferred contain 4 carbon atoms. Representative examples of the most preferred esters are n-butyl acrylate, isobutyl acrylate, butyl methacrylate, isobutyl methacrylate, tertiary butyl acrylate, tertiary butyl methacrylate.

The copolymers may also, after polymerization but prior to ionic crosslinking, be further modified by various reactions to result in polymer modifications, which do not interfere with the ionic crosslinking. Halogenation of an olefin acid copolymer is an example of such polymer modification.

The preferred base copolymers, however, are those obtained by the direct copolymerization of ethylene with a monocarboxylic acid comonomer.

Metal ions, which are suitable in forming the ionic copolymers of the present invention, can be divided into two categories, uncomplexed metal ions and complexed metal ions. In the uncomplexed metal ions the valence of the ion corresponds to the valence of the metal. These metal ions are obtained from the commonly known and used metal salts. The complexed metal ions are those in which the metal is bonded to more than one type of salt group, at least one of which is ionized and at least one of which is not. Since the formation of the ionic copolymers requires only one ionized valence state, it will be apparent that such complexed metal ions are equally well suited in the present invention. The term “metal ion having one or more ionized valence states” means a metal ion having the general formula Me₊ₙ Xₘ, where n is the ionic charge and is at least one, X is a non-ionized groups and n+m equal the valence of the metal. The utility of complexed metal ions employed in the formation of ionic copolymers corresponds in their ionized valences to those of the uncomplexed metal ions. The monovalent metals are, of course, excluded from the class of complexed metal ions but higher valent metals may be included depending on how many metal valences are complexed and how many can be ionized. The preferred complexed metal ions are those in which all but one metal valences are complexed and one is readily ionized. Such compounds are in particular the mixed salts of very weak acids, such as oleic and stearic acid, with ionizable acids, such as formic and acetic acid.

The uncomplexed metal ions which are suitable in forming the ionic copolymers of the present invention, therefore comprise for the α-olefin-monocarboxylic acid copolymers, mono-, di- and trivalent ions of metals in Groups I, II, III, IV-A and VIII of the Periodic Table of Elements (see page 392, Handbook of Chemistry and Physics, Chemical Rubber Publishing Co., 37th ed.). Uncomplexed monovalent metal ions of the metals in the stated groups are also suitable in forming the ionic copolymers of the present invention with copolymers of olefins and ethylenically unsaturated dicarboxylic acids. Suitable monovalent metal ions are Na⁺, K⁺, Li⁺, Cs⁺, Ag⁺, Hg₊ and Cu₊. Suitable divalent metal ions are Be⁺², Mg⁺², Ca⁺², Sr⁺², Ba⁺², Cu⁺², Cd⁺², Hg⁺², Sn₊₂, Pb⁺², Fe⁺², Co⁺², Ni⁺² and Zn⁺². Suitable trivalent metal ions are Al⁺³, Sc⁺³, Fe⁺³and and Y⁺³.

The preferred metals, regardless of the nature of the base copolymer, are Na⁺ and Zn⁺². These metals are preferred because they result in ionic copolymers having the best combination of improvement in solid state properties with retention of melt fabricability. It is not essential that only one metal ion be employed in the formation of the ionic copolymers and more than one metal ion may be preferred in certain applications.

The thermosetting polymer pellets suitable for use in the present invention preferably incorporate crosslinking agents with polymers or copolymers having crosslinkable functionalities, such that, upon application, when the functionalities from a crosslinking agent crosslink with those on the polymer, coatings having additional benefits, such as improved in corrosion resistance, adhesion and mechanical properties, are produced. Several techniques have been disclosed to pre-blend the crosslinking agents with polymers for producing thermosetting polymer pellets. For example, reactivity and process conditions must be such that substantially no crosslinking occurs during the pellet formation process. Generally, the crosslinking agent is dispersed or solubilized in the mixture containing the thermosetting polymer pellets.

Some of the most suitable crosslinkable functionalities on a polymer used in the thermosetting polymer pellets include those that can be thermally crosslinked, actinically crosslinked, or a combination thereof. Some the suitable crosslinkable functionalities include acid or anhydride functionalities. Suitable crosslinking agents include, but are not limited to hydroxyalkylamide and epoxy containing materials, such as diglycidyl ether of bisphenol A, diglycidyl ether of bisphenol F and triglycidyl isocyanurate.

Optionally an additional monomer with hydroxyl functionality, such as, but not limited to, hydroxyethyl acrylate, hydroxyethylmethacrylate or hydroxypropyl methacrylate, can be incorporated into the polymer. Suitable crosslinking agents that can be incorporated into the particles include blocked or free isophorone diisocyanate, blocked toluene diisocyanate and blocked or free tetramethylene diisocyanate. Caprolactone is a commonly used blocking agent. Other crosslinkers known in the art that can be used, include aminoplast crosslinking resin, such as, but not limited to, tetramethoxymethyl glycouril.

Typically, the thermosetting polymer pellets include a crosslinking agent in the stoichiometric range of about 1:0.05 to 1:1.5 with respect to the acid group in the crosslinkable polymer. Preferably, the range is between 1:0.1 to 1:1. The range of acid functionality in the crosslinkable polymer before crosslinking is between about 1 and 30 percent by weight of the ethylene. Preferably, the range is between 4 to 20 percent. The hydroxy functionality in the crosslinkable polymer, when present, before crosslinking is between about 0.001 to 30 percent by weight of the ethylene. Preferably, the range is between 2 to 10 percent.

Step (ii) of the process of the present invention includes heating the polymer pellets in means 5 for heating as the mixture is conveyed under plug flow and plug free conditions through heating means 5. The plug flow plug free conditions are attained in heating means 5 by maintaining the Reynolds Number of the mixture passing through mean for heating 5 at about 2,000 to 500,000, preferably 5,000 to 200,000 and most preferably 6000 to 150,000; and by maintaining the transportation velocity of the polymer pellets in means 5 for heating at or above the Durand's minimum transportation velocity expressed by the following equation:

$${V}_{MH} = {{F}_{1} [ 2 {gD}_{H} ( \frac{Δ ρ}{{ρ}_{medium}} ) ]}^{0.5}$$

where V_{MH} is minimum transportation velocity of the mixture, F₁ is an empirically derived constant that depends on the size of the polymer pellet being conveyed, g is the acceleration due to gravity, DH is the inner diameter of heating sections 26, Δρ is the absolute value of the difference between the densities of the polymer pellets and the aqueous medium and ρ_{medium} is the density of the aqueous medium.

The polymer pellets are melted by the heat transfer fluid, preferably steam under pressure supplied through intake 281 on each of the plurality of heating zones 28. The condensed steam is readily drained from drain 282 in heating zone 28. The temperature of the mixture containing the pellets is raised in steps by the plurality of heating zones 28 as the medium passes from one heating section 26 to the next heating section 26. Depending upon the chemical make up of the pellets, the temperature is raised sufficiently rapidly to permit efficient shearing of the pellets. Preferably, the pellets are heated above T_{g} in case of amorphous polymers and above Tₘ for crystalline and many of the semi-crystalline polymers. Thus, as the pellets exit from means 5 for heating, they are substantially in a molten state. Depending upon the chemical make up of the polymer pellets, the pellets attain temperatures above the melting point or glass transition temperature. By way of example, when Nucrel® RX-76 polymer pellets supplied by DuPont Company of Wilmington, Del., were heated to temperature in the range of 110° C. to 150° C. The residence time of the polymer pellets in means 5 for heating was about 10 to 2 seconds.

A time/temperature profile is preferably utilized during the heating or cooling polymer pellets. By “time/temperature profile” it is meant that lower temperatures can be employed for longer times and higher temperatures for shorter times, all within the temperature ranges and times discussed herein. The balance of time/temperature is important to avoid significant (more than, say, about 35% percent) reaction of the crosslink agent with the copolymer before such crosslinking is desired, which is after application of the particles to the substrate to be coated. The rate at which the temperature is raised during the residence time of the pellets in means 5 for heating depends upon the type of polymer being heated. Thermosetting polymer particles blended with crosslinkers would be highly temperature sensitive as they can prematurely crosslink if exposed to temperatures sufficiently high and a residence time sufficiently long to result in premature crosslinking of more than 35%. Generally, the conditions are adjusted to ensure that any premature crosslinking is no more than about 0.5% to 35%, preferably no more than about 0.1% to 25% and most preferably no more than 0.05% and 10%.

In the next step (iii), melted pellets in the heated mixture exiting from output port 30 enter shearing means 7, which include one or more conventional shear devices 32. The melted polymer pellets are sheared into polymer particles having a desired sphericity, particle size distribution and size range. Typically, shear rates in the range of from about 1000 to 32,000 1/s are employed. When more than one shearing is used, the exiting polymer particles from the first shearing device are preferably reheated to a desired temperature before the reheated particles enter the next shearing device. The size of polymer particles obtained are controlled conventionally, such as by the type of shearing device used, the rate at which the polymer pellets are sheared and the temperatures of the pellets being sheared and the amount of the surfactant added to the mixture. Thus, for the same pellet loading, i.e., amount of pellets added to the mixture, the higher the shear rate, generally the smaller will be the average particle size.

For more difficult to shear polymer particles, such as Nucrel® 960 polymer supplied by DuPont Company, Wilmington, Del., shearing is preferably done in stages by utilizing more than one shear device 32.

Most practical particle size ranges when applied over substrate surfaces in the form of an aqueous slurry are 100 to 10,000 mn, preferably 150 to 6,000 nm, especially preferred 400 to 4,000 nm, and highly preferred 800 to 3,500 nm. Most practical particle size ranges when applied over substrate surfaces in the form of a powder are 100 to 1,000,000 nm, preferably 500 nm to 500,000 nm, especially preferred 1000 to 250,000 nm, highly preferred 2000 to 100,000 nm.

If desired, a desired amount of catalyst can be added through port 34 to the mixture after the melted pellets are sheared. If more than one shearing device 32 is utilized, then the addition of catalyst preferably takes place before the pellets being sheared enter the last shearing device 32. Alternatively, a desired amount of catalyst can be added to the mixture before the melted pellets are sheared.

While a neutralization step is not needed when thermosetting polymers are utilized, it is generally employed when converting ethylene/methacrylic acid polymers to the corresponding ionomers. Some of the suitable neutralizing agents, added through port 54 to control the pH of the aqueous medium, include amines, ammonia, zinc carbonate and metal hydroxides, such as sodium hydroxide. Ammonia, sodium hydroxide, potassium hydroxide and zinc carbonate are preferred.

During (iv) step, the polymer particles exiting from means 7 for shearing are then cooled under plug free conditions through means 9 for cooling. Generally, cooling to room temperature is accomplished fairly rapidly. The rate of cooling, the incoming temperature of the coolant being used is dependent on the chemical make up of polymer particles being cooled. Thus, for example, when temperature sensitive blend of particles containing a thermosetting polymer and a crosslinking agent are sheared, it is preferable to cool them under plug flow cooling conditions to ensure minimal degree of crosslinking, defined earlier. The use of plug flow conditions in cooling thermoplastic polymer particles is also preferred.

When plug flow conditions are utilized in means 9 for cooling; the Reynolds Number of the mixture passing through means 9 for cooling is maintained in the range of about 2,000 to 500,000, preferably 5,000 to 200,000 and most preferably 6000 to 150,000.

Additionally, the transportation velocity of the polymer particles in means 9 for cooling is maintained at or above the Durand's minimum transportation velocity expressed by the following equation:

$${V}_{MC} = {{F}_{2} [ 2 {gD}_{C} ( \frac{Δ ρ}{{ρ}_{medium}} ) ]}^{0.5}$$

where V_{MC} is minimum transportation velocity of the mixture, F₂ is an empirically derived constant that depends on the size of the polymer pellet being conveyed, g is the acceleration due to gravity, D_{c} is the inner diameter of cooling passage 38 of means 9 for cooling, Δρ is the absolute value of the difference between the densities of the polymer pellets and the aqueous medium and ρ_{medium} is the density of the aqueous medium.

As stated earlier, to prevent cavitation either in heating means 5 or in cooling means 9, the pressure of the mixture exiting from means 9 for cooling is reduced to atmospheric pressure from the operating pressure by means, such as let-down pump means 50 connected to an exit passage 44 or by means of capillary tube of a known length. The mixture containing the polymer particles is then stored in a storage tank 48. If desired, additional water may be added via port 54 to storage tank 48.

If desired, the polymer particles from the aqueous slurry may be isolated by any of the well-known methods, including but not limited to decantation, drying, centrifugation, or filtration. FIG. 1A illustrates one such conventional approach where the aqueous slurry is flashed in evaporation chamber 56 through flash nozzle 60 to remove the volatiles via exhaust port 62. The polymer particles 64 in a powder form can then be conventionally removed via exit port 66. Generally, evaporation takes place at sub-atmospheric pressures in the range typically used in such processes.

### EXAMPLES

Unless otherwise specified, all chemicals and reagents were used as received from Sigma-Aldrich, St. Louis, Mo.

### Thermoplastic Materials

The following procedure was used to produce polymer particles of Example A: “NUCREL® 960” ethylene methacrylic acid copolymer (supplied by DuPont Company, Wilmington, Del.) polymer pellets (thermoplastic polymer density of 0.95 g/cc and melting point of 95° C.) having pellet size of about 3 mms were simultaneously fed with agitation into slurry tank 10 with deinoized water and surfactant (Pluronic® F-98 polyoxypropylene-polyoxyethylene block copolymer supplied by BASF Performance Chemicals in Mount Olive, N.J. Cloud point of about 107° C.). The loading of the polymer pellets in the mixture was at 10 weight parts per hundred (PPH) and that of the surfactant was at 1 (PPH). The temperature in slurry tank 10 was maintained 28° C. The mixture was then heated through heating means 5 to heat the polymer pellets under plug flow conditions. The temperature of the mixture was heated by steam at 150° C. supplied at 618 kilopascals (75 psig) system pressure. As a result, the temperature of the mixture at output port 30 was 135° C. Metering pump means 22 supplied pressure at 653 kilopascals (80 psig) at motor RPM of 850. The residence time in heating means 5 was 9.88 seconds. The mixture exiting from output port 30 was sheared in shearing device 32 operating at 1065 RPM. The shear rate was maintained at 7,645 1/s with a shear residence time of 1.43 sec. The mixture containing sheared polymer particles that exited from output passage 38 was then cooled in an agitated cooling passage 40 to a temperature of about 24° C. The coolant was supplied at temperature of 6° C. Motor RPM of pressure let down pump means 50 was 600. The flow rate the mixture at delivery port 24 was 0.0000669 meters³ per second (1.06 GPM) and the flow rate of the mixture exiting out of exit port 44 was 0.0000959 meters³ per second (1.52 GPM). The increase in the GPM rate occurred due to the condensation of steam added in heating zones 28. Initial velocity of the mixture at delivery port 24 was measured 0.22 meters per second (0.72 feet per second) and the final velocity of the mixture at output port 30 was measured 0.31 meters per second (1.03 feet per second). Additionally, Durand's Velocity was determined to be 0.19 meters per second (0.63 feet per second), and as described in the discussion on the plug flow conditions above, this process was determined to be in compliance with the plug flow definition. Rounded polymer particles of an approximate size of less than 100 μ were isolated.

Examples B and C were made using the process as described above. “NUCREL® RX76”, supplied by DuPont, Wilmington, Del. was used in Example B. Low-density polyethylene (LDPE, RIBLENE® MV 10, supplied by Polmeri Europa, Milano, Italy) was used in Example C. The results of Examples A, B and C are summarized in Table 1 below.

### Thermoset Materials

Examples D, E, F and G, summarized in Table 1 below, were done using thermoset materials as described herein.

In Example D, thermosetting polymer pellets were prepared by mixing 100 PPH of Nucrel® RX-76 ethylene methacrylic acid copolymer supplied by DuPont Company, Wilmington, Del. with 40 PPH of ethylene glycidyl methacrylate crosslinking agent supplied by DuPont Company, Wilmington, Del. and then extruder pelletized at 109° C. in a 40 mm extruder. The pellet size was in the range of 3 mm and a polymer density of 0.95 g/cc. The processing temperature of the polymer blend was determined by measuring its dynamic viscosity, which was constant (about 100 Pascal-Second) at 130° C. indicating substantially no crosslinking taking place at that temperature, whereas the dynamic viscosity at 180° C. increased rapidly, indicating the presence of crosslinking taking place. Thus, it can be seen that the thermosetting polymer pellet could be safely processed at less than 130° C. without producing substantially premature crosslinked polymer particles.

The thermosetting polymer pellets described above were simultaneously fed with agitation into slurry tank 10 with deionized water and surfactant (Pluronic® F-98 polyoxypropylene-polyoxyethylene block copolymer supplied by BASF Performance Chemicals in Mount Olive, N.J.). The loading of the polymer pellets in the mixture was at 5 weight parts per hundred (PPH) and that of the surfactant was at 1 (PPH). The temperature in slurry tank 10 was maintained 28° C. The mixture was then conveyed into means 5 for heating to heat the polymer pellets under plug flow conditions. The temperature of the mixture was heated by steam supplied at 150° C. supplied at 618 kiloPascals (75 psig) system pressure. As a result, the temperature of the mixture at output port 30 was 128° C. Metering pump means 22 supplied pressure at 639 kiloPascals (78 psig) at motor 420 RPM. The residence time in heating means 5 was 9.69 seconds The mixture exiting from output port 30 were sheared in shearing device 32 operating at 500 RPM. The shear rate was maintained at 3,589 1/s with a shear residence time of 1.67 sec. The mixture containing sheared polymer particles that exited from output passage 36 was then cooled in a plug flow cooling passage shown in FIG. 3A to a temperature of about 18° C. The coolant was supplied at temperature of 6° C. Motor RPM of pressure let down pump means 50 was 520. The flow rate of the mixture at delivery port 24 was 0.00006309 meters³ per second (1.0 GPM) and the flow rate of the mixture exiting out of exit port 44 was 0.0000820 meters³ per second (1.30 GPM). The increase in the GPM rate occurred due to the condensation of steam added in heating zones 28. Initial velocity of the mixture at delivery port 24 was measured 0.22 meters per second and the final velocity of the mixture at output port 30 was measured 0.29 meters per second. Additionally, Durand's Velocity was determined to be 0.18 meters per second. The process, as described in the discussion on the plug flow conditions above, was determined to be in compliance with the plug flow definition. Rounded polymer particles of an approximate size of 10-50 μm were isolated.

Example E was prepared in a similar manner to Example D. To prepare the starting material, 729 g of an epoxy-functional methacryl copolymer with an epoxy-weight equivalent of 380 and an average molecular weight (Mn) of 2000, 210 g 1,12-dodecanediacid, 30 g of a light protecting agent (1:1-mixture of Tinuvin® 900 (UV-absorber) and Tinuvin® 111 (sterically hindered amine light protecting agent), both from Ciba Specialty Chemicals, Dettingen, Germany), 3 g benzoin, 6 g Irganox® B 225 (antioxidant, Ciba Specialty Chemicals GmbH, Lampertheim, Germany) and 8 g Troy EX 570 (leveling agent, Troy Chemie GmbH, Seelze, Germany) were first mixed in a dry state and then dispersed at 100 to 120° C. by means of an extruder. After cooling off and pre-comminuting of the extrudate, the latter was milled in an air separation ball mill to an average particle size (d50) of 20 μm. The surfactant used was sodium dodecylbenzene sulfonate (SDBS, Pilot Chemical Company, Avenel, N.J.). In this example, two shear devices (32) were used to produce the desired material. The results appear in Table 1 below.

Example F was prepared in a similar manner to Example D. To prepare the starting material, 500 parts COOH-functional polyester of acid equivalent weight equal to 700 g (available from DSM Resins US, Inc., Augusta, Ga.) was added to 500 parts of bisphenol A epoxy resin of epoxy equivalent weight equal to 700 g (available from Dow Chemical Co., Midland, Mich.) and 10 parts benzoin (a degassing aid). The surfactant was DBS. The results appear in Table 1 below.

Example G was prepared in a similar manner to Example F, but 300 parts BaSO₄ (available from Polar Minerals, Lawrenceville, Ga.) were added to the mix. The surfactant was SDBS. The results appear in Table 1 below.

TABLE 1

| Example | A | B | C | D | E | F | G |
|---|---|---|---|---|---|---|---|
| Polymer | Nucrel (R) | Nucrel (R) | LDPE | Nucrel (R) | GMA-DDDA | Houston “clear” | Houston “white” |
| | 960 | RX76 | | RX76-E/GMA | | Polyester-epoxy | Polyester-epoxy |
| Pigment | — | — | — | — | — | — | BaSO4 |
| Pigment loading | — | — | — | — | — | — | 30 pph |
| Polymer type | Thermoplastic | Thermoplastic | Thermoplastic | Thermoset | Thermoset | Thermoset | Thermoset |
| Melting temperature | 95 C. | 93 C. | 108 C. | — | — | — | — |
| Class transition | −10 C. | −10 C. | −122 C. | 97 C. | 52 C. | 63 C. | 63 C. |
| temperature | | | | | | | |
| Polymer density | 950 kg/m³ | 950 kg/m³ | 920 kg/m³ | 950 kg/m³ | 1450 kg/m³ | 1200 kg/m³ | 1440 kg/m³ |
| | 0.95 g/cm³ | 0.95 g/cm³ | 0.92 g/cm³ | 0.95 g/cm³ | 1.45 g/cm³ | 1.20 g/cm³ | 1.44 g/cm³ |
| Polymer loading | 10 pph | 10 pph | 5 pph | 5 Pph | 3 pph | 3 pph | 3 pph |
| Surfactant | F98 | F98 | F98 | F98 | SDBS | SDBS | SDBS |
| Surfactant loading | 1 pph | 0.5 pph | 1 pph | 1 Pph | 1 pph | 0.5 pph | 0.5 pph |
| Slurry tank 10 | 28 C. | 28 C. | 28 C. | 28 C. | 28 C. | 28 C. | 28 C. |
| temperature | | | | | | | |
| Metering pump | 89 rad/s | 89 rad/s | 33 rad/s | 44 Rad/s | 48 rad/s | 65 rad/s | 78 rad/s |
| means 22 speed | 850 rpm | 850 rpm | 315 rpm | 420 Rpm | 459 rpm | 618 rpm | 744 rpm |
| Metering pump | 653 kPa | 653 kPa | 577 kPa | 639 KPa | 584 kPa | 508 kPa | 508 kPa |
| means 22 pressure | 80 psig | 80 psig | 69 psig | 78 Psig | 70 psig | 59 psig | 59 psig |
| Flowrate of mixture | 6.69E-05 m3/s | 6.69E-05 m3/s | 4.73E-05 m3/s | 6.31E-05 m3/s | 6.94E-05 m3/s | 9.46E-05 m3/s | 1.14E-04 m3/s |
| at delivery port 24 | 1.06 gpm | 1.06 gpm | 0.75 gpm | 1.0 gpm | 1.10 gpm | 1.50 gpm | 1.80 gpm |
| Velocity of mixture | 0.22 m/s | 0.22 m/s | 0.17 m/s | 0.22 m/s | 0.24 m/s | 0.33 m/s | 0.40 m/s |
| at delivery port 24 | 0.72 ft/s | 0.72 ft/s | 0.54 ft/s | 0.73 ft/s | 0.80 ft/s | 1.09 ft/s | 1.31 ft/s |
| Durand's velocity (Vm) | 0.19 m/s | 0.19 m/s | 0.17 m/s | 0.18 m/s | 0.23 m/s | 0.30 m/s | 0.39 m/s |
| | 0.63 ft/s | 0.63 ft/s | 0.54 ft/s | 0.58 ft/s | 0.74 ft/s | 0.99 ft/s | 1.26 ft/s |
| Residence time in | 9.88 s | 9.88 s | 12.92 s | 9.69 s | 8.81 s | 6.46 s | 5.39 s |
| Heating means 5 | | | | | | | |
| Temperature of mixture | 135 C. | 100 C. | 140 C. | 128 C. | 130 C. | 110 C. | 110 C. |
| at output port 30 | | | | | | | |
| Flowrate of mixture | 9.59E-05 m3/s | 9.59E-05 m3/s | 6.15E-05 m3/s | 8.20E-05 m3/s | 9.02E-05 m3/s | 1.23E-04 m3/s | 1.48E-04 m3/s |
| at output port 30 | 1.52 gpm | 1.52 gpm | 0.98 gpm | 1.30 gpm | 1.43 gpm | 1.95 gpm | 2.34 gpm |
| Velocity of mixture | 0.31 m/s | 0.31 m/s | 0.22 m/s | 0.29 m/s | 0.32 m/s | 0.43 m/s | 0.52 m/s |
| at output port 30 | 1.03 ft/s | 1.03 ft/s | 0.71 ft/s | 0.94 ft/s | 1.04 ft/s | 1.42 ft/s | 1.70 ft/s |
| Shear device 32 speed | 112 rad/s | 63 rad/s | 17 rad/s | 52 rad/s | 314 rad/s | 22 rad/s | 79 rad/s |
| 1 | 1065 rpm | 600 rpm | 158 rpm | 500 rpm | 3000 rpm | 210 rpm | 753 rpm |
| 2 | — | — | — | — | 314 rad/s | — | — |
| | — | — | — | — | 3000 rpm | — | — |
| Shear rate at shear | 7645 1/s | 4307 1/s | 1134 1/s | 3589 1/s | 21535 1/s | 1507 1/s | 5405 1/s |
| device 32 | — | — | — | — | 31790 1/s | — | — |
| Residence time in shear | 1.43 s | 1.43 s | 2.23 s | 1.67 s | 3.04 s | 1.11 s | 0.93 s |
| device 32 | | | | | | | |
| Temperature of mixture | 24 C. | 32 C. | 16 C. | 18 C. | 35 C. | 37 C. | 27 C. |
| after cooling means 9 | | | | | | | |
| Flowrate of mixture | 9.59E-05 m3/s | 9.59E-05 m3/s | 6.15E-05 m3/s | 8.20E-05 m3/s | 9.02E-05 m3/s | 1.23E-04 m3/s | 1.48E-04 m3/s |
| at exit port 44 | 1.52 gpm | 1.52 gpm | 0.98 gpm | 1.3 gpm | 1.43 gpm | 1.95 gpm | 2.34 gpm |
| Velocity of mixture | 0.31 m/s | 0.31 m/s | 0.22 m/s | 0.29 m/s | 0.32 m/s | 0.43 m/s | 0.52 m/s |
| at exit port 44 | 1.03 ft/s | 1.03 ft/s | 0.71 ft/s | 0.94 ft/s | 1.04 ft/s | 1.42 ft/s | 1.70 ft/s |
| Pressure let down pump | 63 rad/s | 63 rad/s | 41 rad/s | 55 rad/s | 64 rad/s | 81 rad/s | 95 rad/s |
| means 50 speed | 600 rpm | 600 rpm | 390 rpm | 520 rpm | 607 rpm | 775 rpm | 910 rpm |
| Pressure let down pump | 653 kPa | 653 kPa | 529 kPa | 639 kPa | 536 kPa | 508 kPa | 494 kPa |
| means 50 pressure | 80 psig | 80 psig | 62 psig | 78 psig | 63 psig | 59 psig | 57 psig |
| Polymer pellet size | 3 mm | 3 mm | 4 mm | 3 mm | 20 um average | <2 mm | <1 mm |
| | | | | | | >0.125 mm | >0.125 mm |
| Polymer particle size | <100 um | <50 um | <10 um | <50 μm | 20 um average | <100 um | <70 um |
| | | | >1 um | >10 μm | | >1 um | >8 um |

What is claimed is:

1. A process for producing substantially round polymer particles comprising the steps of:
(i) forming a mixture comprising polymer pellets, an aqueous medium and at least one surfactant;
(ii) heating said mixture under plug flow and plug free heating conditions;
(iii) shearing heated mixture; and
(iv) cooling sheared mixture under plug free cooling conditions to produce said substantially round polymer particles.

2. The process of claim 1 wherein said surfactant is blended in said polymer pellets.

3. The process of claim 2 further comprising adding additional portion of said surfactant to said aqueous medium in said step (i) or adding another surfactant to said aqueous medium in said step (i).

4. The process of claim 1 wherein said surfactant is added to said aqueous medium in said step (i).

5. The process of claim 1 or 2 wherein said polymer pellets comprise a thermosetting polymer.

6. The process of claim 1 wherein said polymer pellets comprise a thermosetting polymer and a crosslinking agent.

7. The process of claim 1 wherein said polymer pellets comprise a thermosetting polymer, a crosslinking agent, said surfactant, a pigment and a catalyst.

8. The process of claim 1 or 2 wherein said polymer pellets comprise a thermoplastic polymer.

9. The process of claim 1 wherein said polymer pellets comprise a thermoplastic polymer, said surfactant and a pigment.

10. The process of claim 5 further comprising dispersing or solubilizing a crosslinking agent in said steps (i), (ii) or (iii).

11. The process of claim 5 further comprising dispersing or solubilizing a catalyst in said steps (i), (ii) or (iii).

12. The process of claim 5 wherein said polymer pellets comprise a substantially uncrosslinked blend of said thermosetting polymer and a crosslinking agent.

13. The process of claim 12 further comprising dispersing or solubilizing a catalyst in said steps (i), (ii) or (iii).

14. The process of claim 1 wherein said particles are cooled under plug flow cooling conditions.

15. The process of claim 1 further comprising isolating said polymer particles from said aqueous medium.

16. The process of claim 15 further comprising rinsing said isolated polymer particles with water to remove said surfactant adhered to said polymer particles.

17. The process of claim 1 further comprising reducing the concentration of said surfactant in said mixture by adding water to said medium.

18. The process of claim 1 wherein said heating step comprises injecting steam through a plurality of heating zones positioned on said means for heating.

19. The process of claim 1 wherein said plug flow heating conditions are attained by:
i) maintaining the Reynolds Number of said mixture passing through said means for heating at about 2,000 to 500,000; and
ii) maintaining the transportation velocity of said mixture in said means for heating at or above the Durand's minimum transportation velocity expressed by the following equation:
$${V}_{MH} = {{F}_{1} [ 2 {gD}_{H} ( \frac{Δ ρ}{{ρ}_{medium}} ) ]}^{0.5}$$
where V_{MH} is minimum transportation velocity of the mixture, F₁ is an empirically derived constant that depends on the size of the polymer pellet being conveyed, g is the acceleration due to gravity, D_{H} is the inner diameter of a heating section of said means for heating, ^{Δρ} is the absolute value of the difference between the densities of the polymer pellets and the aqueous medium and ^{ρmedium} is the density of the aqueous medium.

20. The process of claim 14 wherein said plug flow cooling conditions are attained by:
i) maintaining the Reynolds Number of said mixture passing through said means for cooling at about 2,000 to 500,000; and
ii) maintaining the transportation velocity of said polymer particles in said means for cooling at or above the Durand's minimum transportation velocity expressed by the following equation:
$${V}_{MC} = {{F}_{2} [ 2 {gD}_{C} ( \frac{Δ ρ}{{ρ}_{medium}} ) ]}^{0.5}$$
where V_{MC} is minimum transportation velocity of the mixture, F₂ is an empirically derived constant that depends on the size of the polymer pellet being conveyed, g is the acceleration due to gravity, D_{c} is the inner diameter of a cooling passage of said means for cooling, ^{Δρ} is the absolute value of the difference between the densities of the polymer pellets and the aqueous medium and ^{ρmedium} is the density of the aqueous medium.

21. The process of claim 19 or 20 further comprising reducing operating pressure of cooled mixture exiting from said means for cooling to atmospheric pressure.

22. The process of claim 21 wherein said operating pressure is reduced to atmospheric pressure by passing said cooled mixture through a capillary tube.

23. The process of claim 21 wherein said operating pressure is reduced to atmospheric pressure by applying an opposing pressure provided by a pressure let down pump against said cooled mixture exiting from said means for cooling.

24. Substantially round polymer particles made in accordance with the process of claim 1.

25. A process for producing substantially round polymer particles comprising the steps of:
(i) forming a mixture comprising polymer pellets, an aqueous medium and at least one surfactant;
(ii) heating said mixture in means for heating under plug flow and plug free heating conditions to melt said pellets;
(iii) shearing said melted pellets in said heated mixture; and
(iv) cooling said sheared mixture in means for cooling under plug free cooling conditions to produce said polymer particles.

26. A device for producing substantially round polymer particles comprising:
(i) means for forming a mixture of polymer pellets, an aqueous medium and at least one surfactant;
(ii) means for heating said mixture under plug flow and plug free heating conditions;
(iii) means for shearing said heated mixture; and
(iv) means for cooling said sheared mixture under plug free cooling conditions.

27. The device of claim 26 further comprising means for isolating said polymer particles from said aqueous medium.

28. The device of claim 26 wherein a capillary tube is connected to said means for cooling to reduce operating pressure in said means for cooling to atmospheric pressure.

29. The device of claim 28 wherein a pressure let down pump is connected to said means for cooling to reduce operating pressure in said means for cooling to atmospheric pressure by applying an opposing pressure against cooled mixture exiting from said means for cooling.

30. The device of claim 26 wherein said means for heating and cooling are substantially free from obstruction to attain said plug free conditions.

31. The device of claim 26 wherein said polymer pellets comprise a substantially uncrosslinked blend of a thermosetting polymer and a crosslinking agent.

32. The device of claim 31 wherein said means for cooling are adapted to cool said polymer particles in said mixture under plug flow cooling conditions.

33. The device of claim 26 wherein said means for heating comprise a plurality of heating sections interposed with a plurality of heating zones positioned at substantially equidistant intervals.

34. The device of claim 33 wherein said heating zone is provided with at least one injection port.

35. The device of claim 33 wherein said heating zone is provided with at least two injection ports.

36. The device of claim 35 wherein said injection ports are positioned in an opposing relationship to one another.

37. The device of claim 26 wherein said heating zone is provided with at least one drain port for removing excess amount of steam supplied to said heating zone.

38. The device of claim 26 wherein said means for cooling is an elongated cooling passage surrounded by a cooling jacket.
